(19) United States
(12) Patent Application Publication
(10) Pub. No.: US 2003/0185499 A1
(43) Pub. Date: Oct. 2, 2003

(54) High speed optical interconnects

(76) Inventors: Edward Butler, Chandler, AZ (US); Karl H. Mauritz, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/116,010

(22) Filed: Apr. 2, 2002

(51) Int. Cl. G02B 6/28; G02B 6/35

(52) U.S. Cl. 385/24; 385/17

(57) ABSTRACT

High-speed optical interconnects are formed between I/O ports on an electromagnetic device and at least one optical communication channel via a vertical cavity surface emitting laser (VCSEL) array. The VCSEL array of the interconnect is separated into at least two segments, each segment comprising at least one optical communication channel coupled to a respective I/O port.

### FIELD

Embodiments of the invention relate to the field of high-speed optical communication systems; and more specifically, to interconnecting devices using vertical cavity surface emitting lasers.

### BACKGROUND

The need for higher bandwidth in the computing and communications industry has also increased the need for high density and high speed interconnects. These interconnects are typically used between two or more points within a communication system. For example, in digital devices, such as desktop computers, buses are used to interconnect processor and chipsets, chipsets and memory, and various other peripherals that require high performance and a large number of signal lines. High-speed interconnect buses often operate at Gigabits per second (Gbs) data rates.

Some exemplary interconnect materials include copper traces on printed circuit boards, copper cable for mid and long range connections, and optical fiber for high speed, long distance interconnect. For interconnects associated with the processor and chipset of a computer, the copper interconnect is complex. Furthermore, interconnect architectures that require very large integrated circuit (IC) package pin counts are expensive. The decreasing yields also make implementation of large pin counts prohibitive. Interconnects with high performance and large density requirements can often be realized via copper interconnects but at enormous expense and very low yield. However, even using copper interconnects, very high-density cubed processing architectures are unachievable, particularly at high performance levels.

For example, copper interconnects may not work in a system where communication between processor unit cells within the system require multiple signal channels at high-speed communication rates, such as GHz frequencies. A cubed processing structure having multiple cells per side is an example of such a system. For example, a cubed processing structure with 30 cells on each axis has about 27,000 cells. The majority of these cells require six independent data buses via a high bandwidth communication channel to connect the cell to neighboring cells located along the X-axis, Y-axis, and Z-axis. Each cell allows data to flow to the left or right cell on the X-axis channel independently of the Y-axis channel and Z-axis channel resulting in a system requiring about 162,000 high bandwidth communication channels. Copper interconnects cannot presently be used to implement such an architecture within an integrated circuit.

### BRIEF DESCRIPTION OF THE DRAWINGS

A more particular description of the invention will be rendered by references to specific embodiments thereof, which are illustrated in the appended drawings. Understanding that these drawings depict only typical embodiments of the invention and are not to be considered limiting of scope, the invention will be described and explained with additional specificity and detail through the use of the accompanying drawings.

FIG. 1 illustrates one embodiment of a cubed processing system.

FIG. 2 is a side view of one embodiment of a processing unit cell as illustrated in FIG. 1.

FIGS. 3A-3F are top views illustrating various embodiments of segmented interfaces for use with the processing unit cell as illustrated in FIG. 2.

### DETAILED DESCRIPTION

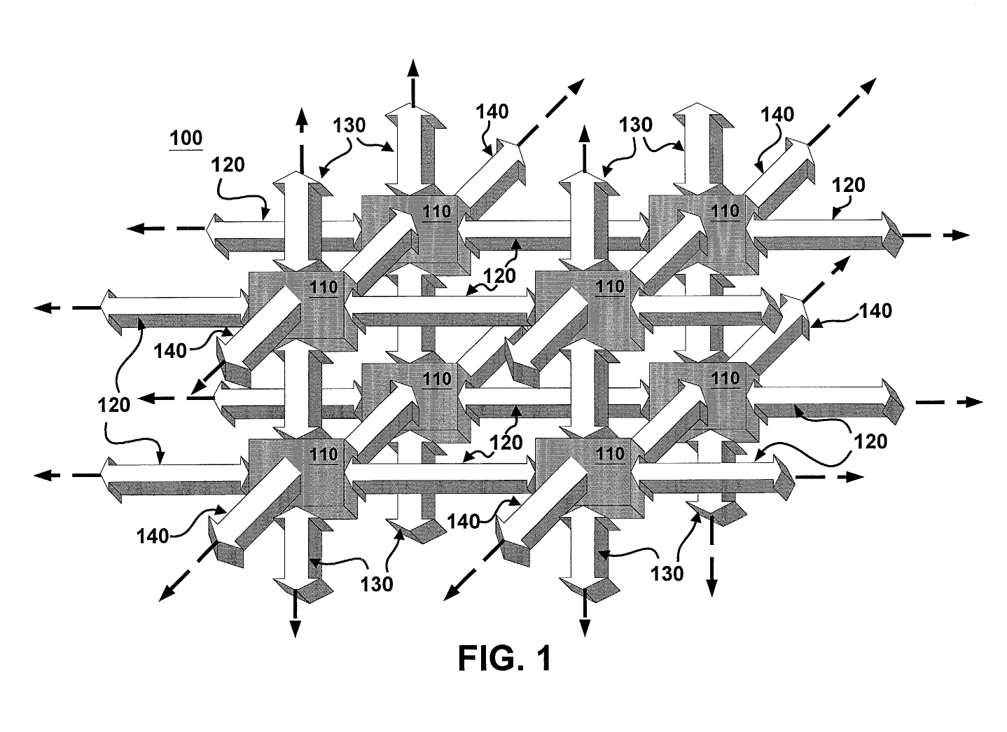

A system and apparatus providing high speed optical interconnects is described. High speed optical interconnects are necessary for properly configuring multiple cell-based processing architectures, such as the cubed processing architecture illustrated in FIG. 1. Various embodiments of the invention can be applied to an apparatus, system or architecture that requires high-speed and/or dense interconnection between multiple destination points from a central origination point. Embodiments of the invention quickly convey data coming in to and out of processing units to the next network device in the network via a partitioned vertical cavity surface emitting laser array. Exemplary environments where embodiments of the invention may be used to interconnect devices within the system include Intel® Platform architectures, Local Area and Wide Area Networking, multiple cell type processor architectures, memory architectures, Front side busses, components on a central processing unit (CPU), direct interconnect to peripheral components, and the like.

Reference in the specification to “one embodiment” or “an embodiment” and “one configuration” or “a configuration” denote that a particular feature, structure, or characteristic described in connection with the embodiment is included in at least one embodiment of the invention. The appearances of the phrase “in one embodiment” in various places in the specification do not necessarily all refer to the same embodiment. Similarly, the phrase “in one configuration” does not necessarily refer to the same configuration.

Vertical Cavity Surface Emitting Laser (VCSEL), as that term is used herein, refers to the combination of hardware wherein a vertical laser cavity or lasing chamber is used to emit laser light signals from the surface of the device. While the principles involved in the operation of a VCSEL are very similar to those of regular edge-emitting lasers, the VCSEL changes the orientation of the laser cavity and replaces the traditional reflective ends with partially reflective layers, positioned above and below the laser cavity. More specifically, the VCSEL has several layers of partially reflective mirrors above and below an active “lasing” layer where the particles are excited. Layers of semiconductor with differing compositions create these mirrors, and each mirror reflects a narrow range of wavelengths back into the cavity in order to cause light emission at just one wavelength. A VCSEL offers several advantages over edge-emitting lasers. For example, during manufacturing of edge-emitting lasers, the laser is cut out of the material from which they were formed and packaged prior to testing. The packaging stage is a very expensive process and if the edge-emitting laser fails the tests, all of the packaging costs have been wasted. In contrast, testing of a VCSEL can occur during the wafer stage prior to packaging, because they emit light from their surface. Furthermore, VCSEL designs tend to be more energy efficient than edge-emitters. For example, the VCSEL exhibits a lower threshold current, thereby reducing the overall power consumption during use. Finally, the light beam from a VCSEL can be configured to be narrower and more circular, making it easier to direct the light into an optical fiber. The low-power VCSEL wavelength that produces the lowest loss in optical fibers is at a wavelength of about 1550 nanometers. Optical transceivers that use wavelengths between about 1290 nm and 1330 nm, such as the Intel® TXN 1701 transceiver, are designed for transmitting optical signals across distances of up to about 10 km. While the lowest loss VCSEL technology is specified in the 2 GHz range, a lower-power VCSEL may still be useful in short-distance networks. The lower-power VCSEL typically uses wavelengths between about 367 nm and about 850 nm. As such, the wavelength of the optical transmitter can be partially determined by the desired distance of transmission and the type of transmission medium relaying the optical signal. Power consumption in VCSEL optical signaling is about one tenth of the electrical consumption similar copper-based interconnect. As previously discussed, the shape and size of optical signal generated by a VCSEL may even reduce degradation rates in optical fiber over other types of optical signals. As a result, transmitter/receiver design complexity is greatly reduced due to the diminished dynamic range.

The optical fiber may be used as an optical communication channel in an electronic device to deliver data coming in and out of the processing unit to the correct port on the next network device in the network. High-density optical fiber bundles and connectors are achieving interconnect densities never achieved before in similar copper-based interconnect. In one embodiment, the optical communication channels may be part of a switching fabric, which utilizes integrated circuits and corresponding software to control switching paths through a larger network. It is appreciated that although several embodiments illustrate a cubed processing architecture or a cubed processor unit cell, the switching fabric may take many other architectural forms, and furthermore is independent of the infrastructure used to transfer data between network devices in the network.

As previously discussed, in accordance with one embodiment of the invention, applications requiring varying numbers of parallel communication channels regardless of architectural form are accommodated through a segmented VCSEL array. The segmented VCSEL array, as that term is used herein, refers to the combination of hardware wherein multiple VCSEL devices are configured into an array, which is physically and/or logically partitioned into multiple segmented partitions. Each partitioned segment is then aligned with a corresponding communication channel. In one embodiment, the segmented VCSEL array is coupled with a connector, which couples and aligns an array of fiber bundles to the segmented VCSEL array. The VCSEL array distributes signals via the fiber bundle array to various destinations. The fiber bundle array may also include distinct groups of varying lengths. The signals are often transmitted in parallel fashion to the destinations. As such the high speed optical interconnects created via the segmented VCSEL array provide scalable high-density interconnects, which also exhibit low power consumption at a relatively low cost.

Ball Grid Array (BGA), as that term is used herein, refers to the combination of hardware used as a packaging alternative for high I/O (Input/Output) devices that have high thermal and electrical performance requirements, such as microprocessors, microcontrollers, ASICs, memory, PC chip sets, and other similar devices. The BGA reduces inductance via shorter electrical paths, eliminates mechanical problems due to fragile leads, and increases both the density and reliability of surface mounting. There are a variety of acceptable BGA types including plastic overmolded BGAs (PBGAs), flex tape BGAs (TBGAs), high thermal metal top BGAs (HL-PBGAs), and high thermal BGAs (H-PBGAs). Typically, the BGA greatly reduces coplanarity problems and other handling issues, because there are no leads in a BGA to bend. For example, during reflow the solder balls are self-centering, up to 50% off the contact pads, thus reducing placement problems during surface mount. An exemplary PBGA package includes a wire-bonded die on an organic substrate made of a plurality-metal layer copper clad Bismaleimide Triazine (BT) laminate, such as four-metal layer or two-metal layer substrates. The die and bonds are protected and encapsulated with molding compound. Holes drilled through the substrate provide routing from the leads to the respective eutectic solder balls on the underside of the substrate. Various BGA configurations are utilized to connect the processing unit to the VCSEL array and the device containing the processing unit to an appropriate electrical power supply.

FIG. 1 and the following discussion are intended to provide a brief, general description of one suitable computing environment 100 in which high speed optical interconnects may be implemented and is not to be construed as limiting. Specifically, FIG. 1 illustrates a multiple cell-based processing architecture and operational environment. Those skilled in the art will appreciate that the cell-based processing architecture may be practiced by employing combinations of processing units using a wide variety of different types of computer system configurations, including general purpose central processing units (CPU), application specific integrated circuits (ASIC), servers, network processing units (NPU), network switches, personal computers, hand-held devices, multi-processor systems, microprocessor-based or programmable consumer electronics, network PCs, minicomputers, mainframe computers, Personal Digital Assistants, digital cameras, and the like.

The computing environment 100, such as a cubed processing environment, enables communication between processor unit cells 110 and neighboring processor unit cells 110 within the system via multiple signal channels at high-speed communication rates. Typically, a cubed processing structure has neighboring processing unit cells 110 along each axis; the majority of these cells connect via data buses or high bandwidth optical communication channels 120, 130, and 140. More specifically, each processing unit cell 110 allows data to flow to the left or right cell along the X-axis optical channels 120 independently of the Y-axis optical channels 130 and Z-axis optical channels 140. As previously, discussed the number of required channels exponentially increases with respect to the number of cells within the computing environment 100 so that about 162,000 optical channels are needed for a cubed computing environment with about 30 cells on each axis.

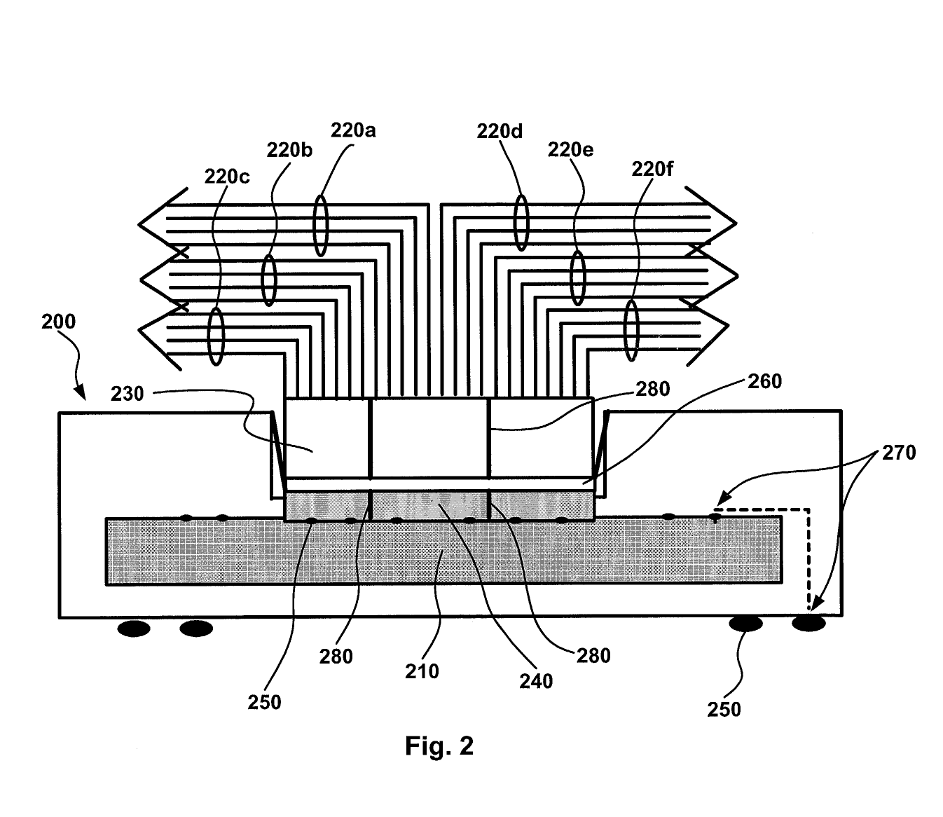

FIG. 2 depicts a side view of one embodiment of the invention illustrating an individual processing unit cell 200, which may be employed in multiple cell systems requiring dense multiple interconnects, such as the system illustrated in FIG. 1. The illustrated processing unit cell 200 includes a processing unit 210, optical fiber bundles 220a-220f, a connector 230, a VCSEL array 240, BGAs 250, a focal chamber 260, and power interconnects 270. In one embodiment, the processing unit 210 is a compound semiconductor placed on a packaging substrate. The BGA packaging technology used in BGAs 250 enables communication between the VCSEL array 240 and the processing unit 210. The power interconnect 270 energizes the BGA, facilitating communication to the VCSEL array and activation of the lasers within the array.

In one embodiment, a differential input buffer associated with the VCSEL array 240 receives signals via the BGA from the processing unit 210. The differential input buffer amplifies the signals to drive the VCSEL array 240 into producing an outgoing photon signal stream. The photon signal stream is received at a neighboring processing unit cell and converted back into electrons via a photo detector. The electron signal is amplified and converted into a data signal, such as a differential signal or a single-ended signal. In one embodiment, the BGA may receive and transmit signals at the same time. In this case, a receiver on both sides of the BGA must subtract the transmitted driver signal from the receiver's side to receive the signal being transmitted from the opposite side. For optimal performance when the BGA is being used to simultaneously transceive signals, the impedance for drivers on both side should match the BGA to reduce signal reflections.

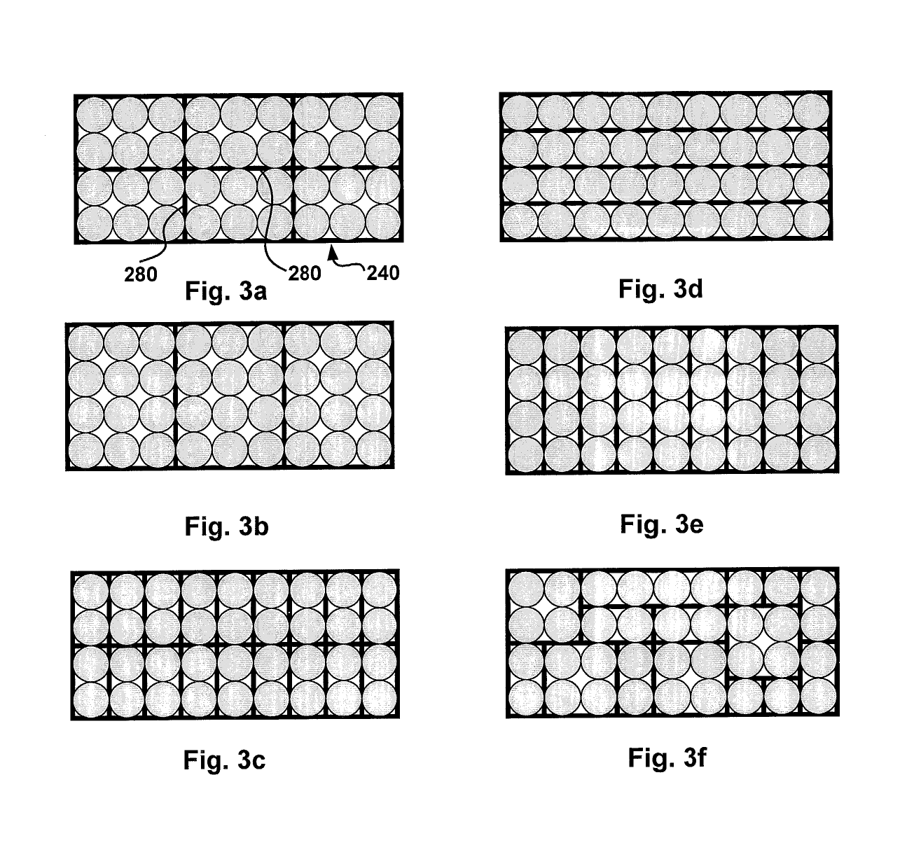

The optical fiber bundles 220 and VCSEL array 240 are logically and physically isolated into smaller segments via partitions 280 (see FIG. 3a). Connector 230 helps to align and couple the segments of the VCSEL array 240 with the corresponding segments in the fiber bundle 220. The focal chamber 260 of the connector 230 may provide holographic distortion of the optical signals being transmitted between the VCSEL array 240 and the fiber bundles 220. The holographic distortion can focus and align the output of the photodiodes in the VCSEL array 240. The focal chamber 260 may also sharpen signals received from the optical fiber bundle prior to relaying the signals to photo detectors in the VCSEL array 240.

For the illustrated embodiment, partitioned fiber bundles 220a-220f provide six different optical communication channels, one for each axis within the cubed processing structure. Each fiber bundle 220 is routed to a destination, such as a neighboring processing unit cell. The independent optical fiber bundles 220a-220f are plugged into the connector 230. The molded one-piece fiber bundle connector 230 is partitioned such that multiple fiber bundles 220a-220f, which are organized into optical communication channels, can be independently attached to the connector 230, e.g. an array of fiber bundles. These optical communication channels exit the molded connector in distinct groups that allow distribution of signals to various destinations of varying lengths in a parallel fashion. In applications where a varying number of parallel optical communication channels are required, e.g. one implementation requires X number of optical communication channels and another Y number of optical communication channels, a dummy plug can be added to the connector 230 in place of a fiber bundle 220. For example, a memory system with a varying number of memory modules or a corner cube who's interconnect requirement is four sides rather than six can employ the dummy plug. These embodiments may also be implemented using an alternative partitioning scheme from that employed in FIG. 3a. Thus the optical communication channel provides at a relatively low cost, a means of achieving scalable, high density interconnect while attaining other desirable systems performance objectives, such as lower power usage.

Referring now to the partitioned structures in FIGS. 3a-3f, the VCSEL array used in the various embodiments can vary according to the function of the connection with the processing cell. The partitions logically and physically isolate the VCSEL array into smaller segments, according to the functions of the corresponding interconnect. One skilled in the art recognizes that the configuration of the processing structure or even the individual processing cells can vary according to the function and purpose of the structure. As the structures vary, so too may interconnect segments between these structures vary. For example, certain cells or nodes within the processing structure may only receive data, while others only transmit or broadcast data, and others monitor communications within the structure. The number of photodiodes and photo detectors required for each segment may also vary according to the function of corresponding interconnect. For example, if the distance between source and destination is large the VCSEL array segment may need more photodiodes for a stronger signal. The high-speed optical interconnects using a VCSEL array can also be used to interconnect memory, front side busses, CPUs, or as direct interconnect with peripherals and other “off chip” components.

In the bi-directional cubed processing structure described in FIG. 1, the VCSEL array technology interconnects the processor unit cells within the cubed structure to neighboring cells. In one configuration, the VCSEL array 240 of the processing cell is partitioned 280 into six segments as illustrated in FIG. 3a. Each segment of the VCSEL array 240 having about 50 photodiodes and about 50 photo detectors. Each cell within the cube structure coupling the respective VCSEL array 240 with six fiber bundles, which exit each “face” of the cell. Each fiber bundle being destined for an adjacent cube, or, as need be, interconnecting to another edge of the cube in a wrap around fashion.

While the invention has been described in terms of several embodiments, those skilled in the art will recognize that the invention is not limited to the embodiments described, but can be practiced with modification and alteration within the spirit and scope of the appended claims. All changes that come within the meaning and range of equivalency of the claims are to be embraced within their scope. The description is thus to be regarded as illustrative instead of limiting.

What is claimed is:

1. An apparatus comprising:
an electromagnetic device having at least two Input/Output (I/O) ports; and
a vertical cavity surface emitting laser (VCSEL) array to couple with an optical communication channel, the VCSEL array having at least two segments, each segment being in communication with a respective I/O port.

2. The apparatus of claim 1, wherein each segment of the VCSEL array comprises at least one photodiode and at least one photo detector.

3. The apparatus of claim 2, wherein the VCSEL array comprises six segments, each segment having about 50 photodiodes and about 50 photo detectors.

4. The apparatus of claim 1, wherein the VCSEL array further comprises a photodiode and a photo detector.

5. The apparatus of claim 1, wherein each segment of the VCSEL array is optically and electrically isolated from the other segment(s) of the VCSEL array.

6. The apparatus of claim 1, wherein the I/O ports are coupled to the VCSEL array via a ball grid array (BGA).

7. The apparatus of claim 1, wherein the optical communication channel further comprises:
a partitioned optical fiber bundle connector proximate to the VCSEL array, each partition being optically aligned to direct optical signals from a segment of the VCSEL array; and
an array of optical fiber bundles attached to the partitioned connector to receive optical signals.

8. The apparatus of claim 1, wherein the VCSEL array further comprises an optical signal transmitter that generates an optical signal for transmission to a destination.

9. The apparatus of claim 8, wherein a wavelength of the optical signal is partially determined by a distance of transmission and a transmission medium for the optical signal.

10. The apparatus of claim 8, wherein the optical signal has a wavelength between about 367 nanometers and about 1550 nanometers.

11. The apparatus of claim 10, wherein the optical signal has a wavelength of about 850 nanometers.

12. The apparatus of claim 10, wherein the optical signal has a wavelength between about 1290 nm and about 1330 nanometers.

13. The apparatus of claim 8, the apparatus further comprising a connector to align the optical communication channel to the VCSEL array.

14. The apparatus of claim 13, wherein the connector is configured to optically align the optical signal via holographic distortion.

15. A system comprising:
a processing unit having at least two input/output (I/O) ports;
a vertical cavity surface emitting laser (VCSEL) array separated into at least two segments each segment comprising at least one vertical cavity surface emitting laser coupled to a respective I/O port; and
optical communication channels coupled to the segments of the VCSEL array to distribute optical signals via the VCSEL array.

16. The system in claim 15, wherein each optical communication channel is aligned with a respective segment of the VCSEL array.

17. The system in claim 15, wherein each optical communication channel comprises about fifty fiber channels.

18. The system in claim 17, wherein each optical communication channel further comprises about 50 transmitters and about 50 photo detectors.

19. The system in claim 17, wherein the fiber channels are grouped together.

20. The system in claim 15, wherein each segment of the VCSEL array further comprises a transmitter and a photo detector.

21. The system in claim 15, wherein the optical communication channels are connected and aligned with a connector coupled to the VCSEL array.

22. The system in claim 21, wherein the connector has a focal chamber to optically align signals passing through the focal chamber via holographic distortion.

23. A system for transporting data, the system comprising:
a plurality of processing units each processing unit having a vertical cavity surface emitting laser (VCSEL) array to transceive data signals; and
optical communication channels coupled to and optically aligned with the VCSEL array.

24. The system in claim 23, wherein the optical communication channel further comprises a holographic chamber that focuses the VCSEL array.

25. The system in claim 23, wherein the optical communication channel comprises optical fiber bundles to connect a respective processing unit with at least one of a plurality of neighboring processing units.

26. The system in claim 23, wherein the VCSEL array is partitioned into at least two segments.

27. The system in claim 26, wherein each segment of the VCSEL array comprises at least 50 photodiodes.

28. The system in claim 26, wherein each segment of the VCSEL array comprises at least 50 photo detectors.

29. The system in claim 26, wherein each segment of the VCSEL array is optically and electrically isolated from the other segments in the VCSEL array.

30. The system in claim 23, each processing unit further comprising:
a compound semiconductor containing digital logic; and
a packaging substrate abutting the compound semiconductor, the substrate having a ball grid array (BGA) electrically coupled to the digital logic, the BGA comprising at least two input/output ports coupled to the VCSEL array.

31. The system in claim 30, each processing unit further comprising a differential input buffer that is electrically coupled with the BGA and the VCSEL array, the differential input buffer amplifying received data signals and driving the VCSEL array to produce outgoing photons for transmission via at least one optical communication channel.

32. The system in claim 30, each processing unit further comprising a photo detector coupled with at least one optical communication channel, the photo detector to receive incoming photons for conversion into data signals.

33. The system in claim 32, wherein the incoming photons are converted into electrons and the electrons are amplified and/or converted into differential signals for transmission via the BGA.

34. The system in claim 30, wherein the BGA is configured to simultaneously transceive signals between the VCSEL array and the digital logic.

35. A method of interconnection comprising:
receiving a data signal;
generating an optical signal based on the data signal using a vertical cavity surface emitting laser (VCSEL); and
transmitting the optical signal to a destination via an optical communication channel.

36. The method of claim 35, further comprising receiving a second optical signal from the destination.

37. The method of claim 36, further comprising partitioning the VCSEL into an array of segments each segment independently transceiving optical signals.

38. The method of claim 35, wherein transmitting further comprises distributing optical signals to multiple destinations via the optical communication channel.

39. The method of claim 38, wherein transmitting optical signals to multiple destinations further comprises partitioning the optical communication channel into linked groups each linked group being connected to a respective destination.

40. The method of claim 35, wherein transmitting the optical signal further comprises transmitting the optical signal to selected destinations at varying lengths in parallel fashion.

41. The method of claim 35, wherein the optical communication channel is an array of fiber bundles.

42. The method of claim 35, wherein the VCSEL comprises a segmented array of transmitters and photo detectors.

43. An apparatus comprising:
a segmented and physically partitioned VCSEL array;
a connector coupled to the VCSEL array;
a fiber bundle coupled to the connector and optically aligned with the VCSEL array, the fiber bundle partitioned such that multiple optical communication channels can be independently attached to the connector.

44. The apparatus in claim 43, wherein each optical communication channel is an array of fiber bundles.

45. The apparatus in claim 44, wherein a dummy plug can be added to the connector in place of an optical communication channel.

46. The apparatus in claim 45, wherein the dummy plug is removable.

47. The apparatus in claim 44, wherein an optical communication channel within the array of fiber bundles can be split into a second array of fiber bundles.

48. The apparatus in claim 44, wherein signals generated by the VCSEL array are distributed in parallel fashion via the optical communication channels.

49. The apparatus in claim 43, wherein signals are distributed to various destinations located at a plurality of distances via respective optical communication channels.

50. The apparatus in claim 43, wherein the VCSEL array is electrically connected to a memory system with a varying number of memory modules via a ball grid array (BGA).

51. The apparatus in claim 43, wherein the connector is a molded one-piece fiber bundle connector fixably attached to the fiber bundle.

52. The apparatus in claim 43, each fiber bundle comprising a sub-group of transmit optical fibbers and a sub-group of receive optical fibers.
